(19) United States
(12) Patent Application Publication
(10) Pub. No.: US 2015/0278798 A1
(43) Pub. Date: Oct. 1, 2015

(54) METHOD FOR PROTECTING SENSITIVE DATA TRANSMITTED IN AN NFC SYSTEM

(71) Applicant: INSIDE SECURE, Meyreuil (FR)

(72) Inventors: Matthias Lerch, Septemes les Vallons (FR); Vincent Alimi, Blainville sur Orne (FR); Bastien Latge, La Cadiere D'Azur (FR); Bernard Vian, Gemenos (FR)

(21) Appl. No.: 14/432,406

(22) PCT Filed: Sep. 17, 2013
(86) PCT No.: PCT/FR2013/052127

§ 371 Date: Mar. 30, 2015

(30) Foreign Application Priority Data
Sep. 28, 2012 (FR) 12 59170

(51) Int. Cl. G06Q 20/32; G06Q 20/38; H04B 5/00

(52) U.S. Cl. CPC G06Q 20/3278; H04B 5/0031; G06Q 20/382

(57) ABSTRACT

The present invention relates to a transaction method between a secure processor and a transaction server, via a non-secure processor or a non-secure link, connected to a routing controller, the method including steps of: the controller transmitting to the secure processor, a command message sent by the non-secure processor or by the non-secure link, the controller receiving a response message sent by the secure processor, and the controller transmitting the response message to the non-secure processor or via the non-secure link, the controller analyzing the content of the response message so as to detect data of a first type therein, and removing detected data of the first type from the response message before transmitting it to the non-secure processor or via the non-secure link.

The present invention relates to Near Field Communication (NFC) transactions, and in particular to transactions performed between a contactless microcircuit card and an NFC terminal such as a mobile terminal integrating an NFC component.

NFC components may have several operating modes, i.e. a “reader” mode, a “card emulation” mode, and a “device” mode (also referred to as “device-to-device” or “peer-to-peer” mode). In the “reader” mode, the NFC component operates like a standard RFID reader to read- or write-access an RFID chip (chip card or contactless tag). In this mode, the NFC component emits a magnetic field, sends data by modulating the amplitude of the magnetic field and receives data by load modulation and inductive coupling.

In the “emulation” mode, described in particular in patent EP 1 327 222 in the name of the applicant, the NFC component operates in a passive manner like a transponder. In this mode, the NFC component is seen by an NFC terminal in reader mode and dialogues with the latter like an RFID chip. Thus, the NFC component does not emit any magnetic field, receives data by demodulating a magnetic field emitted by the other reader and sends data by modulating the impedance of its antenna circuit (load modulation).

In the “device” or “peer-to-peer” mode, the NFC component must pair with an NFC terminal also being in the same operating mode. The component and the terminal communicate with each other by alternately placing themselves in a passive state (without emitting any field) to receive data, and in an active state (emitting field) to send data, or remain in a same passive or active state during a transaction.

In addition to these three operating modes (other operating modes may be designed in the future), an NFC component can implement several contactless communication protocols and is for example capable of exchanging data according to the ISO 14443-A protocol, the ISO 14443-B protocol, the ISO 15693 protocol, etc. Each protocol defines a frequency of emission of the magnetic field, a modulation method for modulating the amplitude of the magnetic field to send data in active mode, and an inductive coupling load modulation method to send data in passive mode. An NFC component is thus a multimode and multi-protocol device. The applicant markets for example such an NFC component under the name “MicroRead™”.

Due to its extended communication capacities, an NFC component is intended to be integrated into portable devices such as mobile telephones like smartphones, tactile tablets, notebook or laptop computers. Such a portable device forms an NFC system also referred to as “NFC chipset”, i.e. a chipset comprising an NFC component and at least one host processor. “Host processor” means any integrated circuit comprising a microprocessor and/or a microcontroller and that is connected to a port of the NFC component. Many NFC systems comprise several host processors, such as the main processor of the device in which the NFC component is installed, and a secure processor. The main processor is generally a non-secure processor, for example the baseband circuit (or radiotelephone circuit) of a mobile telephone. The secure host processor is for example the microcontroller present in a SIM or UICC (Universal Integrated Circuit Card) card or a microcontroller present in the NFC component. The resources of the NFC component are thus provided to the host processors to enable them to manage contactless applications.

Using such an NFC system is contemplated to perform secure transactions such as payment transactions with an external secure processor comprising an NFC communication interface, like those implemented in contactless credit cards. The external secure processor can also be integrated into another NFC system, then operating in “card emulation” mode.

However the main processor of an NFC system such as a telephone is not secured. It can therefore execute a malicious application designed to retrieve confidential information stored in an external secure processor such as the one in a card communicating according to an NFC-type protocol with the NFC component of the system. Confidential data may relate to a bank card like its ID number, expiry date, the name of its holder, its verification code, etc. Indeed, this confidential data is generally not transmitted in a protected (encrypted) form in particular because some of this data, like the first figures of the bank card number, is used to route the transaction data within bank networks. Such data is also transmitted in clear for reasons of compatibility of standards or of versions of standards, particularly upward compatibility, such data being transmitted in this way by the first payment cards put into service.

To overcome such a problem, it has been suggested to put in place a protected operating mode of the NFC system in which all of the information exchanged between the non-secure host processor of the NFC system and the external processor passes through a secure processor of the NFC system. The secure processor is then configured to remove from the data to be transmitted to the non-secure host processor all the data the confidentiality of which must be preserved, or to encrypt such data so that only authorized entities can access the encrypted data. If the secure processor is integrated into the NFC component that is a closed component having a specific operating system, it is relatively difficult to extract therefrom confidential data received from an external processor before such data is transmitted to the secure processor of the NFC component. If the secure processor is not integrated into the NFC component, a specific transmission channel, possibly secure, can be established between the NFC component and the secure processor.

However, provision is made so that this protected operating mode is activated by changing the value of an indicator managed by the non-secure host processor. The result is that a malicious application executed by the non-secure host processor can deactivate the protected mode simply by changing the value of the indicator. The confidential data is then no longer filtered by the secure processor and the malicious program can thus obtain the confidential data.

It is thus desirable to increase the protection security of confidential data likely to be transmitted to an NFC system either by an NFC card or by another NFC system in “card emulation” mode. It is also desirable to protect such data when it is likely to be sent by a secure element in such a system or to the outside the latter.

Some embodiments relate to a transaction method between a secure processor and a transaction server, via a non-secure processor or a non-secure link, connected to a routing controller, the method comprising steps of: the routing controller transmitting to the secure processor a command message sent by the non-secure processor or by the non-secure link, the routing controller receiving a response message sent by the secure processor, and the routing controller transmitting the response message to the non-secure processor or via the non-secure link. According to one embodiment, the method comprises steps of: the routing controller analyzing the content of the response message so as to detect data of a first type therein, generating a modified message by removing from or by modifying in the response message at least one portion of the data detected, and transmitting the modified message to the non-secure processor or via the non-secure link.

According to one embodiment, the routing controller systematically analyzes the content of all the response messages received, without analyzing the content of the command messages.

According to one embodiment, the method comprises steps of the routing controller analyzing the command message and of activating the analysis of the content of response messages if the analysis of the command message reveals that data of the first type is likely to be contained in a subsequent response message.

According to one embodiment, the method comprises steps of: determining for each command message received by the routing controller, whether data of the first type is likely to be contained in the corresponding response message, and activating or deactivating the analysis of the content of the corresponding response message, depending on whether data of the first type is likely to be contained in the corresponding response message.

According to one embodiment, the routing controller modifies the data of the first type detected in the response message, generates a modified response message by replacing the detected data of the first type with the modified data in the response message, and transmits the modified response message to the non-secure processor.

According to one embodiment, the modification of the data of the first type detected in the response message comprises steps of transmitting the detected data to a secure processor connected to the routing controller, of the secure processor generating the modified data by encrypting at least one portion of the extracted data, and of the secure processor transmitting the modified data to the routing controller, the non-secure processor transmitting the modified response message to an intermediate server with a key identifier enabling the intermediate server to determine a decryption key, the intermediate server decrypting the encrypted data in the modified response message and restoring the original response message by replacing in the modified response message the encrypted data with the decrypted data, the restored response message being transmitted to a transaction server.

According to one embodiment, when data of the first type has been detected in the response message, the routing controller transmits the response message to a secure processor connected to the routing controller and to the non-secure processor, the secure processor transmitting to the non-secure processor the response message in an encrypted form.

According to one embodiment, the content of messages is analyzed by the routing controller only if an operating mode indicator of the operating mode of the routing controller indicates that the routing controller is in a non-protected mode.

According to one embodiment, data of the first type is detected based on the value of tag fields contained in the response message.

According to one embodiment, the analysis of the content of the response message comprises a step of verifying that the length of a data field of the response message corresponds to the value of a length field contained in the response message.

According to one embodiment, the method comprises a step of the routing controller analyzing the command message to determine a transaction protocol or a format of data exchanged between the non-secure processor and the NFC device, the transaction protocol or the data format thus determined being used to search for data of the first type in the response message.

Some embodiments also relate to a non-secure processor and a routing controller communicating with a secure processor, configured to implement the method defined above, the routing controller being configured to: analyze the content of a response message sent by the secure processor and intended for the non-secure processor or intended to be transmitted via a non-secure link, in response to a command message transmitted by the routing controller to the secure processor, so as to detect data of a first type therein, generate a modified message by removing from or by modifying in the response message at least one portion of the data detected, and transmit the modified message to the non-secure processor or via the non-secure link.

According to one embodiment, the secure processor is integrated into an integrated circuit card comprising a near field communication interface in NFC communication with the routing controller, or is connected to the routing controller.

According to one embodiment, the routing controller is associated with a secure processor configured to: receive all the response messages in a protected operating mode of the routing controller and only the response messages containing data of the first type in a non-protected operating mode, and encrypt the messages received before transmitting them to the non-secure processor.

According to one embodiment, the routing controller is associated with a secure processor configured to: receive from the routing controller data of the first type extracted from the messages received by the routing controller, encrypt the data of the first type received, and transmit the encrypted data to the routing controller, the routing controller being configured to replace the data of the first type with the encrypted data received in the response message, and to transmit the response message thus modified to the non-secure processor.

Some examples of embodiments of the present invention will be described below in relation with, but not limited to, the accompanying figures, in which:

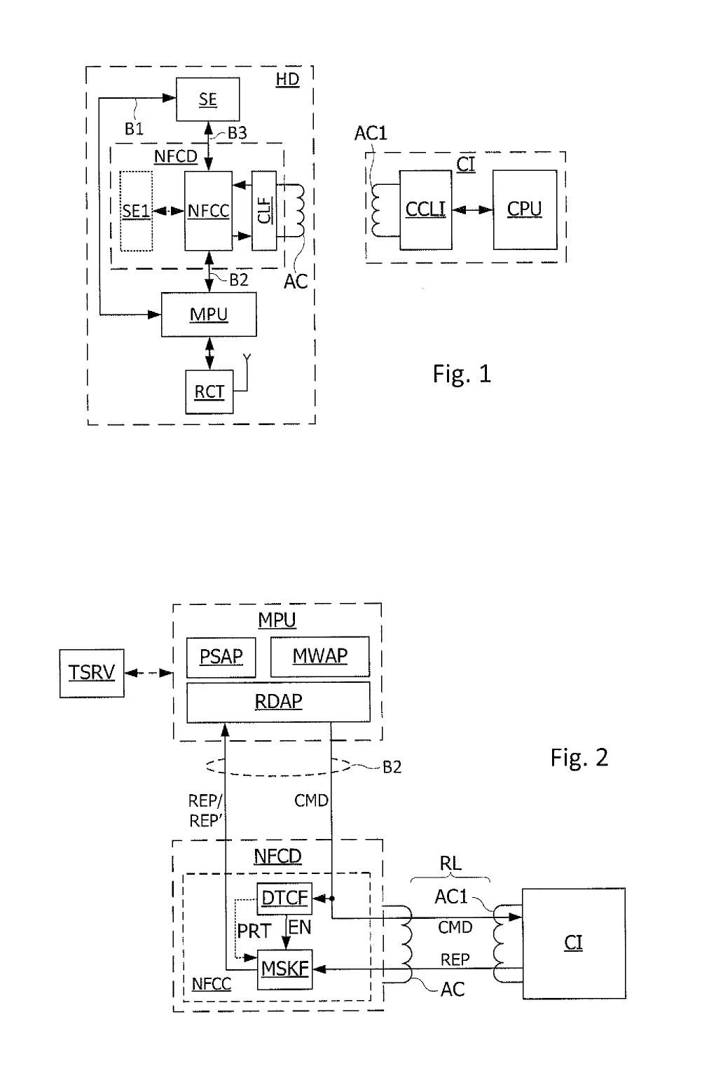

FIG. 1 schematically represents an example of NFC system capable of communicating via an NFC link with an external processor,

FIGS. 2 to 4 schematically represent an NFC system communicating according to an NFC-type protocol with an external processor, according to various embodiments,

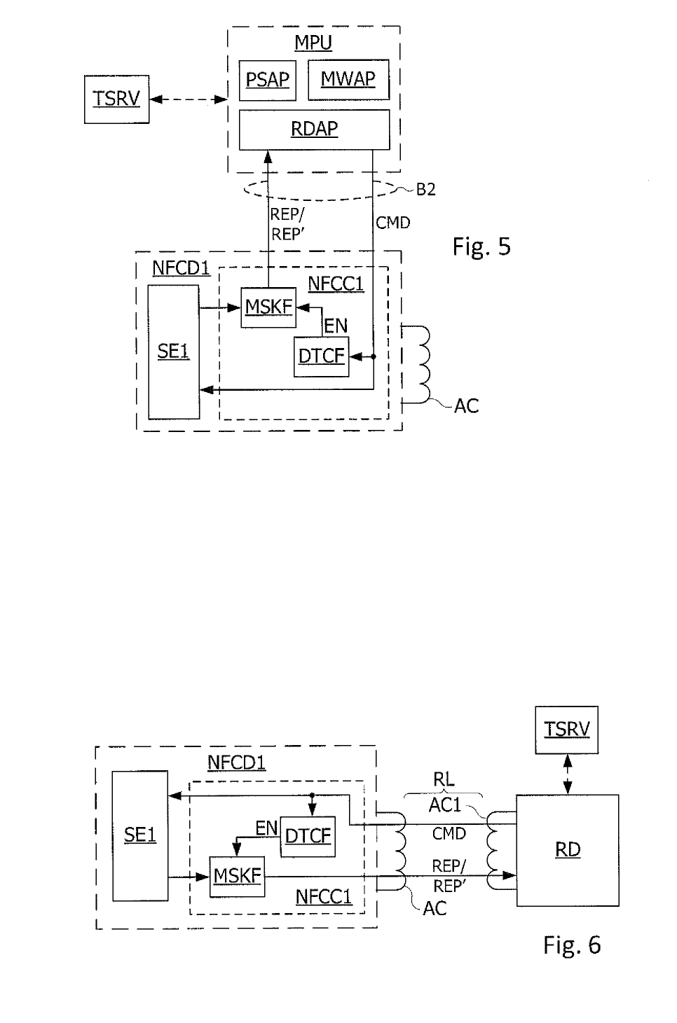

FIG. 5 schematically represents the NFC system communicating with a remote server through a communication link other than an NFC link, according to another embodiment,

FIG. 6 represents the NFC system communicating according to an NFC-type protocol with an NFC terminal, according to another embodiment,

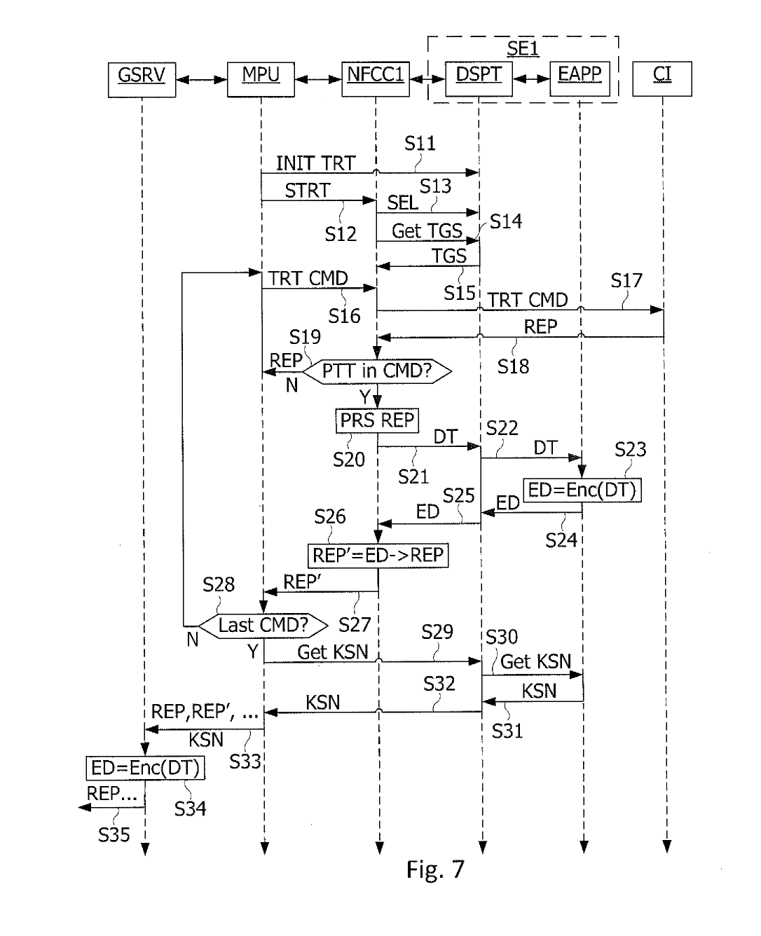

FIG. 7 represents steps executed by the NFC system communicating with an external processor.

FIG. 1 represents an example of an NFC system in NFC communication with an external processor. The system comprises a host processor MPU, a secure element SE, and an NFC component, referenced NFCD. The processor MPU can connect to remote servers via communication circuits RCT. The processor MPU and the secure element SE can be integrated into a portable device HD such as a mobile telephone, a laptop or desktop computer or a tactile tablet. The component NFCD is configured to perform near field communication transactions with an external NFC device, such as an integrated circuit card referenced CI.

The processor MPU can be the main processor or the processor managing the communications of the device HD with one or more wireless and/or hard-wire communication networks.

The secure processor SE can be a Subscriber Identity Module (SIM) card or more generally an integrated circuit card UICC, or even a micro Secure Digital (micro-SD) card. The element SE can be connected to the processor MPU via a link B1 which can be of ISO 7816 or Single Wire Protocol (SWP) type.

The component NFCD comprises an NFC controller, referenced NFCC, ensuring in particular routing functions, and an NFC communication interface circuit, referenced CLF, comprising an antenna circuit AC. The controller NFCC can be coupled to the processor MPU through a link B2 for example of Universal Asynchronous Receiving Transmitting (UART) type and to the processor SE through a link B3 for example of Single Wire Protocol (SWP), Digital Contact Less Bridge (DCLB) or ISO 7816 type.

The component NFCD may also comprise a secure element SE1 such as a secure processor, connected to the controller NFCC. The controller NFCC is configured in particular to route data received from the circuit CLF to one of the processors MPU and SE (and possibly SE1) and route data coming from one of the processors MPU and SE (or SE1) to the circuit CLF.

The integrated circuit CI comprises a processor CPU linked to an antenna circuit AC1 via an NFC interface circuit, referenced CCLI.

FIG. 2 represents the processor MPU communicating with the external integrated circuit CI through the component NFCD and a non-secure near field communication link RL. The processor MPU comprises a communication software layer RDAP configured to provide communication services NFC with an external processor through the controller NFCC and the interface circuit CLF, and an application program PSAP using the communication services provided by the layer RDAP. The program PSAP can communicate with a remote server TSRV for example through the circuits RCT to perform a transaction between the circuit CI and the server TSRV.

According to one embodiment, the controller NFCC comprises a function DTCF for detecting commands and, as applicable, communication protocols, and a masking function MSK. The function DTCF is arranged to intercept and retransmit all the commands CMD sent by the processor MPU, to be transmitted by the interface circuit CLF, or simply to listen to these commands. The function DTCF is configured to detect whether a command CMD sent by the processor MPU (by an application program PSAP) can trigger a response from the integrated circuit containing data to be protected. The function DTCF sends a filter-enabling signal EN that is transmitted to the function MSKF, the state of the signal EN depending on the content of each command CMD. Thus, the signal EN is in the active state if the command CMD received by the controller NFCC contains a request for data to be protected, i.e. data that must not be transmitted to a malicious program MWAP possibly installed in the processor MPU.

The function MSKF is configured to intercept all the response messages REP received from the circuit CI by the controller NFCC, and to transmit these messages to the processor MPU when the signal EN is in an inactive state. When the signal EN is in the active state, the function MSKF is configured to locate data to be protected in each response message REP received. If data to be protected is located, the function MSKF generates a modified message REP′ corresponding to the message REP but in which the located data to be protected is removed, encrypted or replaced with other data. The function MSKF then transmits the message REP or REP′ accordingly to the processor MPU.

The function DTCF can also detect communication protocols or transaction types, or even the format of transmitted data, then transmit to the function MSKF data PRT relating to the protocol or to the transaction type or to the format of detected data, enabling the function MSKF to locate the data to be protected. The function MSKF may then implement different functions of locating data to be protected according to the protocol, transaction type or format data PRT supplied by the function DTCF.

The tables in Appendix 1 give examples of commands and responses which can be successively exchanged between the processor MPU and the integrated circuit CI, during a Paypass Magstripe-type transaction. These commands and responses are defined in particular by the EMV (Europay, MasterCard and Visa) standard. In accordance with this type of transaction, the processor MPU successively sends the following commands:
SELECT PPSE (Paypass Payment System Environment),
SELECT AID (Application Identifier),
GPO (GET PROCESSING OPTIONS),
READ RECORD, and
COMPUTE CRYPTOGRAPHIC CHECKSUM.

As shown in Appendix 1, the circuit CI in NFC communication with the system HD provides a response to each of these commands. The Application Protocol Data Unit (APDU) format used for this type of transaction specifies a format of commands received and of responses supplied by a secure element. According to this format, the command messages CMD comprise the following fields:
CLA: Class datum,
INS: Instruction,
P1: Parameter 1,
P2: Parameter 2,
Lc: Length of the data field,
Data: Data field, and
Le: Length of the expected response message (on 0 if undetermined).

According to the APDU format, the response messages REP to the command messages CMD comprise the following fields:
Data: Data field,
SW1: State datum 1, and
SW2: State datum 2.

The data fields of the command and response messages can be structured in accordance with the TLV format (Tag-Length-Value), a value field itself possibly comprising one or more nested data fields.

In Appendix 1, the “SELECT PPSE” command enables the processor MPU to indicate to the processor CPU of the circuit CI that it wishes to begin a transaction of a certain type. If it has a compatible application dedicated to payment transactions, the processor CPU responds to this command by supplying a response containing an application identifier AID of an application capable of performing a payment transaction in the circuit CI. It shall also be noted as indicated in Appendix 1 that the response to the command “SELECT PPSE” may comprise four nested “Value” fields. For example, the value of the identifier AID “A0 00 00 00 04 10 10” supplied by the processor CPU corresponds to an application capable of performing a MasterCard-type debit-credit transaction.

Upon receiving the response to the “SELECT PPSE” command, and if it has a dedicated application, required by the processor CPU to perform the payment transaction, the processor MPU sends the “SELECT AID” command to activate in the processor CPU the application corresponding to the identifier AID received. In response, the processor CPU sends a message to confirm that the application referenced AID is activated.

After receiving the response to the “SELECT AID” command, the processor MPU sends the “GPO” (“GET PROCESSING OPTIONS”) command. This command enables the transaction to be initiated within the application AID and information to be obtained about the context of the transaction to be performed with the application AID activated by the processor CPU, such as AIP (Application Interchange Profile) and AFL (Application File Locator).

Upon receiving the response to the GPO command, the processor MPU sends the “READ RECORD” command. This command enables data to be obtained from the application relating to the transaction, referenced in the AFL as data relating to a bank card, if the circuit CI is the circuit of a bank card. As indicated in Appendix 1 concerning the response to the “READ RECORD” command, the circuit CPU transmits in clear (non encrypted) the PAN (Primary Account Number) number, the name of the holder, the expiry date of the bank card, and the service code (three figures), i.e. all of the information necessary to perform a remote payment.

According to one embodiment, to prevent such information from being recovered by a malicious program (MWAP) installed in the processor MPU, the function DTCF is configured to detect, based on each command sent by the processor MPU, when such information can be sent by the processor CPU communicating with the processor MPU. The function DTCF activates the signal EN when such a detection is performed.

According to one embodiment, the function DTCF is configured to detect that a sensitive transaction such as a payment transaction is or is going to be triggered, for example by determining whether the data field of the “SELECT AID” command corresponds to a payment transaction application. When the signal EN is active, the function MSKF is configured to analyze the responses to the “READ RECORD” command received. Such responses can be identified by the presence of a tag with a value of “70” (in hexadecimal representation) used in the heading of the response to this command (cf. Appendix 1). Once such a response is identified, the function MSKF is configured to analyze the response, so as to detect the tag preceding the data to be protected. In the example given in Appendix 1, this tag is equal to “56” (in hexadecimal representation). Once the tag “56” is located, the function MSKF can replace the data that follows (PAN, name of the holder, expiry date, verification code) with other data by respecting the value of the length field associated with the tag “56” in accordance with the TLV format. The function MSKF can also change the value of the length field associated with the tag, for example force it to an arbitrary value such as 1, and replace the data to be protected with a datum of length equal to the arbitrary value. The function DTCF is configured to deactivate the signal EN at the end of a transaction or when a new command received cannot result in the processor CPU supplying data to be protected.

According to another embodiment, the function DTCF activates or deactivates the signal EN upon receiving each command CMD sent by the processor MPU, depending on whether or not the corresponding response message REP, susceptible of being sent by the processor CPU, can contain data to be protected. Thus, in the example given in Appendix 1, the function deactivates the signal EN upon receiving the “SELECT”-, “COMPUTE CRYPTOGRAPHIC CHECKSUM”- and “GPO”-type command messages CMD, and activates this signal upon receiving the “READ RECORD”-type command messages REP.

It shall be noted that data protection is thus ensured without involving any secure element situated in the component NFCD or outside this component.

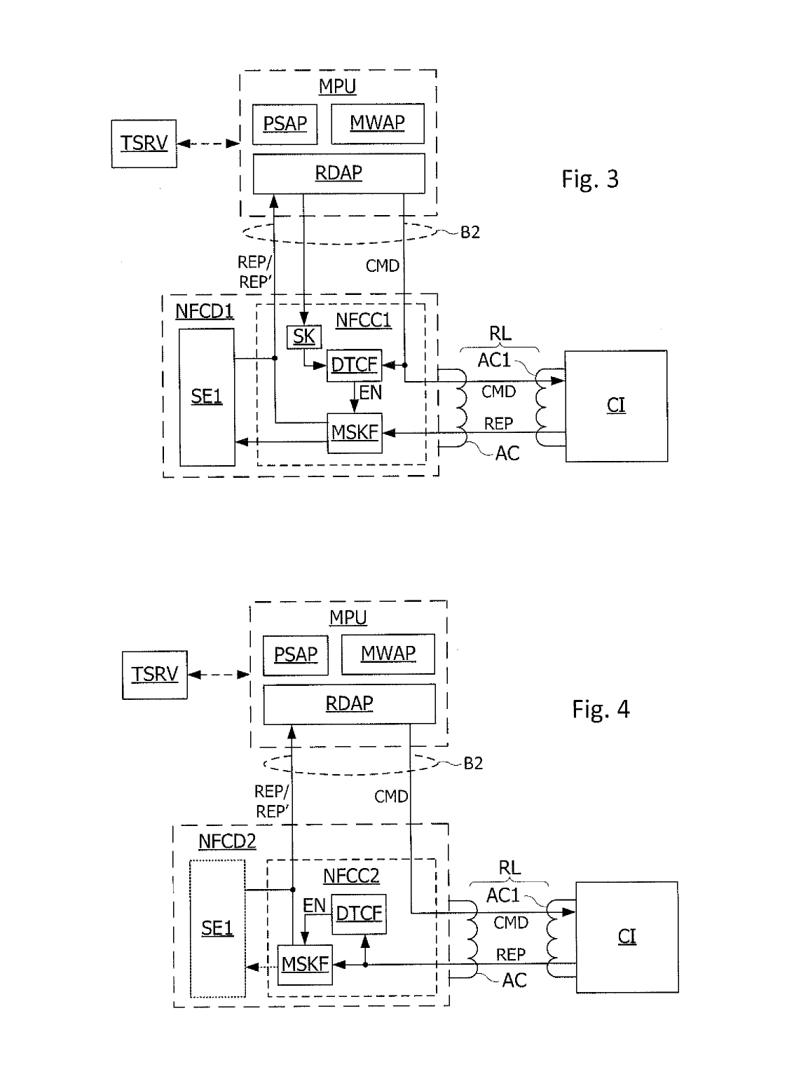

FIG. 3 represents a component NFCD1 according to another embodiment. The component NFCD1 differs from the component NFCD in that it comprises a controller NFCC1 and the secure element SE1. The controller NFCC1 may comprise a register to store a security mode indicator SK the value of which can be modified by the processor MPU. When the security mode is activated, the controller NFCC1 routes all the responses received by its interface CLF to the secure element SE1 which may or may not then retransmit them to the processor MPU, possibly in a modified form, depending on predefined rules. The secure element SE1 can then implement security functions to protect the confidentiality and possibly the integrity of data received by the interface CLF. When the value of the indicator SK is modified to deactivate the security mode, the function DTCF is activated to detect the possible receipt of data to be protected and activate the function MSKF (using the signal EN), so as to detect the presence of such data and remove them from the response messages REP′ that are retransmitted to the processor MPU.

It shall be noted that the component NFCD (FIG. 2) may also comprise the indicator SK, as the function DTCF is active only when the indicator SK is deactivated. When this indicator is activated, the response messages received by the controller NFCC can be transmitted by a secure channel established with the secure element SE of the system HD (via the link B3 indicated on FIG. 1).

Instead of removing the data to be protected from the response messages REP, the function MSKF may transmit the response messages to the secure element SE1 when such messages contain data to be protected (without the controller NFCC1 being in protected mode). The element SE1 may then take any appropriate measure to protect such data, such as encrypting this data using a known encryption key of a secure program which can be installed in the processor MPU or in a remote server.

FIG. 4 represents a component NFCD2 according to another embodiment. The component NFCD2 comprises a controller NFCC2 and optionally the secure element SE1. The controller NFCC2 differs from the controller NFCC in FIG. 2 or 3 in that the function DTCF performs its detection task not on the commands received from the processor MPU, but on the response messages received by the interface CLF. The functions DTCF and MSKF can then be merged, or the function DTCF can be removed. In the example of transaction given in Appendix 1, the function DTCF can activate the signal EN when the tag “70” appears in the heading of a response message received. This embodiment is particularly appropriate when, given the applications installed in the circuits CPU susceptible of being put into communication with the processor MPU via the component NFCD2, and the transaction protocols and the formats of commands and responses used by these applications, there is no possible ambiguity on the content of the response messages REP likely to be received by the component NFCD2.

It will be understood that such a detection only in the response messages REP can also be performed in the embodiment in FIG. 3.

According to another embodiment, the functions DTCF and MSKF can be configured to protect only data transmitted in accordance with a certain transaction protocol or respecting a certain format. Thus, in the example of transaction given in Appendix 1, the function DTCF can activate the signal EN only when the tag “70” appears in the heading of a response message received, and the function MSKF can remove only the data situated in the field associated with the tag “56”, before retransmitting the response message received to the processor MPU.

Provision may be made so that the function DTCF of the controller NFCC2 performs a control of the format of the response messages REP when it detects according to the header data of the message that data to be protected may be contained in the message. Thus, in the example in Appendix 1, when the tag “70” is detected in the heading of a response message REP, the function DTCF can particularly check that the value of the length of the message provided after the tag corresponds to the length of the data field of the message. In this way, the function DTCF can remove certain ambiguities concerning the format and the content of the response message.

In all the embodiments described above, provision may be made to use the indicator SK and to take account of the value of this indicator to activate the function DTCF.

FIG. 5 represents the NFC system in FIG. 3 communicating with a remote server TSRV through the processor MPU (and the communication circuits RCT). FIG. 5 corresponds for example to the use of the secure element SE1 (instead of the circuit CI) to perform a transaction with the server TSRV. Here, it is possible for the component NFCD1 not to comprise any register for storing the security mode indicator SK.

According to one embodiment, the controller NFCC1 can activate the function DTCF when a transaction is initiated by the processor MPU with the secure element SE1, when the security mode indicated by the indicator SK is not activated, or in the absence of this indicator. As above, the function DTCF detects in the command messages CMD transmitted by the processor MPU and intended for the element SE1 whether response messages REP to these commands may contain data to be protected. If this is the case, the function DTCF activates the function MSKF which detects data to be protected in the response messages supplied by the element SE1 and encrypts any data detected in the response messages before transmitting the latter to the processor MPU.

FIG. 6 represents the NFC system in FIG. 3 communicating with an NFC terminal referenced RD, In this case, the component NFCD operates in card emulation mode. In this configuration, it can also be desirable to protect the confidential data stored by the element SE1 when it is transmitted via the near field communication link RL that is not secure. Here again, the controller NFCC1 can activate the function DTCF when a transaction is initiated between the terminal RD and the secure element SE1, when the security mode indicated by the indicator SK is not activated, or in the absence of this indicator. As above, the function DTCF detects in the command messages CMD transmitted by the terminal RD and intended for the element SE1 whether response messages REP to these commands may contain data to be protected. If this is the case, the function DTCF activates the function MSKF which detects data to be protected in the response messages supplied by the element SE1 and encrypts any data detected in the response messages before transmitting the latter to the terminal RD.

The functions DTCF and MSKF can be produced in the form of an application, or applet, which can be adapted according to the transmission protocol or to the format of the data to be processed. For example, all the tags to be recognized in the command messages and/or the response messages can be loaded in addition to the application.

It will be understood that, in the embodiments in FIGS. 5 and 6, the detection of data to be protected can be carried out by the detection function DTCF only on the response messages REP.

FIG. 7 represents steps S11 to S35, executed by the processor MPU, the controller NFCC1 and an external processor communicating with the controller NFCC1 via an NFC link (case of FIGS. 2 to 5). In the example in FIG. 7, the encryption of the data to be protected is performed by an application EAPP of the secure element SE1. The element SE1 comprises a routing function DSPT which routes the commands received to the application of the element SE1, receiving the command. In step S11, the processor MPU transmits a transaction initiating message INIT TRT to the element SE1. In step S12, the processor MPU transmits to the controller NFCC1 a message STRT for activating the data protection. In steps S13 and S14, the controller NFCC1 receives the message STRT and queries the element SE1 to obtain the list of the tags to be used to detect the data to be protected. In step S15, the element SE1 transmits to the controller NFCC1 a list of tags to be monitored TGS, determined on the basis of the message INIT TRT specifying a type of transaction.

In step S16, the processor MPU transmits a first command message CMD to the controller NFCC1 for the external processor CI. The message CMD is retransmitted by the controller NFCC1 to the processor CI in step S17. In step S18, the processor CI sends a response message REP. The message REP is received by the controller NFCC1 which tests the presence of tags introducing data to be protected into the message REP in step S19, If no datum to be protected is detected, the message REP is transmitted to the processor MPU without any modification, otherwise the controller NFCC1 executes step S20. In step S20, the controller NFCC1 extracts the data DT associated with each tag located in step S19. The data thus extracted DT is transmitted to the secure element SE1 in steps S21 and S22. In step S23, the element SE1 encrypts the data DT using an encryption function Enc. In steps S24 and S25, the encrypted data obtained ED is transmitted to the controller NFCC1. In step S26, the controller NFCC1 receives the encrypted data ED and inserts it into the response message REP to replace the data DT. In step S27, the controller NFCC1 transmits a response message REP′ to the processor MPU, the message REP′ containing the data ED replacing the data DT. In step S28, the processor determines whether the command message CMD is the last message of the transaction initiated in steps S11, S12. If the message CMD is not the last one of the transaction, the steps S16 to S28 are executed again with a next command message.

If the processor MPU determines that the message CMD is the last message of the transaction, in step S28, it executes step S29. In step S29, the processor MPU transmits to the controller NFCC1 a message requesting an encryption key identifier used in step S23. This request message is transmitted to the element SE1 in step S30. In step S31, the element SE1 transmits an encryption key identifier KSN. The identifier KSN may comprise for example an identifier of the element SE1 and a transaction counter value. This identifier is transmitted by the controller NFCC1 to the processor MPU in step S32. In step S33, the processor MPU transmits all the response messages REP, REP′ supplied by the processor CI, possibly modified, and the key identifier KSN to an intermediate server GSRV dedicated to the decryption of the data. The server GSRV determines from the identifier KSN received a decryption key enabling the data ED contained in the modified messages REP′ received to be decrypted. In step S34, the server GSRV extracts and decrypts the data EC in the modified messages REP′, then restores the corresponding messages REP, and transmits in step S35 all the messages received REP and possibly restored, to a server receiving the transaction, for example TSRV.

The encryption function Enc implemented in step S23 by the element SE1 can be a Format Preserving Encryption-type (FPE) function, which preserves the format of the data. The function ENC may depend on the type of datum to be encrypted. Thus, in the case of a bank card number, consisting of 16 figures, only a portion of the 16 figures may be modified. According to one example, the first six figures of the card number are kept so as to be able to route the transaction data to the bank issuing the card. All or part of the other figures of the card can be encrypted using an appropriate encryption algorithm, by using an encryption key which can be determined by the server GSRV from the identifier KSN. The encryption algorithm can be AES (Advanced Encryption Standard) or 3DES (Triple Digital Encryption Standard).

The steps in FIG. 7 can also be executed by the systems in FIGS. 5 and 6. In the system in FIG. 5, the transaction, and in particular the steps S17 and S18, is then performed with an application of the element SE1 rather than with an external integrated circuit. In the system in FIG. 6, the steps performed by the processor MPU are executed by the terminal RD, and the steps performed by the circuit CI are executed by an application of the element SE1.

It will be understood by those skilled in the art that the present invention is susceptible of various alternative embodiments and various applications. In particular, the invention also applies to other sensitive transactions, such as VISA qVSDC, VISA MSD CVN17, VISA MSD Legacy, MasterCard MChip -Select 4, -Lite 4, -Mobile, -Flex, American Express AEIPS, Discover D-PAS, Japan Credit Bureau (JCB), Carte Bleue (CB), Eurocheque, Maestro, etc.

In transactions compliant with the EMV standard, a “Track1 Discretionary Data” data field identified by the tag “9F1F” or a “Track2 Equivalent Data” data field is transmitted in response to a “READ RECORD” command. The function DTCF can therefore activate the function MSKF upon sending each “READ RECORD” command, and the function MSKF can seek to detect the tag “9F1F” in the response messages received.

In the transactions of VISA qVSDC type, data to be protected (PAN, name of the holder, expiry date, service code, etc.) is transmitted in a “Track2 Equivalent Data” data field identified by the tag “57”, this field being transmitted in response to a “GPO”-type command. The function DTCF can therefore activate the function MSKF upon sending each “GPO” command, and the function MSKF can seek to detect the presence of the tag “57” in a response message received. In the example of an NFC system capable of handling transactions of VISA qVSDC, EMV and Paypass Magstripe type, the function DTCF can activate the signal EN only when sending “GPO” and “READ RECORD” command messages. The function MSKF (when it is activated by the signal EN) can then be configured to search in the response messages REP for tags (“56”, “57”, “9F1F”) introducing data fields of “Track1 Discretionary Data” or “Track2 Equivalent Data” type.

Furthermore, this application also covers all the possible combinations of the embodiments described above.

APPENDIX 1 being an integral part of the description

### PayPass Magstripe Transaction (Track 1)

SELECT PPSE command

### Command

| Values | Comment |
|---|---|
| 00 A4 | Command = SELECT |
| 04 00 | P1 - P2 |
| 0E | Length = 14 |
| 32 50 41 59 2E 53 59 53 2E 44 44 46 30 31 | Value = Directory Name |
| | (=2PAY.SYS.DDF01) |
| 00 | Response length |

### Response

| Values | Comment | |
|---|---|---|
| 6F | Tag = Response Message Template | |
| 23 | Length = 35 | |
| 84 | Value | Tag = Directory |
| 0E | | Length = 14 |
| 32 50 41 59 2E 53 59 | | Value (=“2PAY.SYS.DDF01”) |
| 53 2E 44 44 46 30 31 | | |
| A5 | | Tag = File Control Information |
| 11 | | Length = 17 |

| | | |
|---|---|---|
| BF OC | Value | Tag = Issuer Data |
| 0E | | Length = 14 |

| | | |
|---|---|---|
| 61 | Value | Tag = Directory Entry Length |
| 0C | | Length = 12 |

| | | |
|---|---|---|
| 4F | Value | Tag = AID |
| 07 | | Length = 7 |
| A0 00 00 00 04 10 10 | | Value (=MasterCard Credit/Debit) |
| 87 | | Tag = App. priority indicator |
| 01 | | Length = 1 |
| 01 | | Value |

| | |
|---|---|
| 90 00 | SW1-SW2 |

SELECT AID command

### Command

| Values | Comment |
|---|---|
| 00 A4 | Command = SELECT |
| 04 00 | P1 - P2 |
| 07 | Length = 7 |
| A0 00 00 00 04 10 10 | Value = AID |
| 00 | Response length |

### Response

| Values | Comment | | |
|---|---|---|---|
| 6F | Tag = Response Message Template | | |
| 17 | Length = 23 | | |
| 84 | Value | Tag = Directory Name | |
| 07 | | Length = 7 | |
| A0 00 00 00 04 10 10 | | Value = AID | |
| A5 | | Tag = Issuer Template | |
| 0C | | Length = 12 | |
| 50 | | Value | Tag = App. Label |
| 0A | | | Length |
| 4D 61 73 74 65 72 43 61 72 64 | | | Value = “MasterCard” |

| | |
|---|---|
| 90 00 | SW1 - SW2 |

GPO command

### Command

| Values | Comment |
|---|---|
| 80 A8 | Command = GPO |
| 00 00 | P1 - P2 |
| 02 | Length = 2 |
| 83 00 | Value |
| 00 | Response length |

### Response

| Values | Comment | |
|---|---|---|
| 77 | Tag = Response Message Template | |
| 0A | Length = 10 | |
| 82 | Value | Tag = App. Interchange Profile (AIP) |
| 02 | | Length = 2 |
| 00 00 | | Value |
| 94 | | Tag = App. File Locator |
| 04 | | Length = 4 |
| 08 01 01 00 | | Value |

| | |
|---|---|
| 90 00 | SW1 - SW2 |

READ RECORD command

### Command

| Values | Comment |
|---|---|
| 00 B2 | Command = READ RECORD |
| 01 | P1 (Record number) |
| 0C | P2 (Reference Control Parameter) |
| 00 | Response length |

### Response

| Values | Comment | | |
|---|---|---|---|
| 70 | Tag = Record Template | | |
| 7F | Length = 127 | | |
| 9F 6C | Value | Tag = App. Version Nr. | |
| 02 | | Length = 2 | |
| 00 01 | | Value | |
| 56 | | Tag = Track1 Discretionary Data | |
| 3E | | Length = 62 | |
| 42 | | Value | Format Code |
| 35 34 31 33 31 32 33 34 | | | PAN (=5413123456784800) |
| 35 36 37 38 34 38 30 30 | | | |
| 5E | | | field separator |
| 53 55 50 50 4C 49 45 44 | | | Name of the holder |
| 2F 4E 4F 54 | | | |
| 5E | | | field separator |
| 30 39 30 36 | | | Expiry date (YYMM) |
| 31 30 31 | | | Service code |
| 33 33 30 30 30 33 33 33 | | | other data |
| 30 30 30 32 32 32 32 32 | | | |
| 30 30 30 31 31 31 31 30 | | | |

| | |
|---|---|
| 9F 64 | Tag = Track1 ATC³ Digit Nr. |
| 01 | Length = 1 |
| 03 | Value |
| 9F 62 | Tag = Track1 BitMap for CVC3¹ |
| 06 | Length = 6 |
| 00 00 00 38 00 00 | Value |
| 9F 63 | Tag = Track1 BitMap for UN² & ATC³ |
| 06 | Length = 6 |
| 00 00 00 00 E0 E0 | Value |
| 9F 65 | Tag = Track2 BitMap for CVC3¹ |
| 02 | Length = 2 |
| 00 0E | Value |
| 9F 66 | Tag = Track2 BitMap for UN² & ATC³ |
| 02 | Length = 2 |
| 0E 70 | Value |
| 9F 6B | Tag = Track2 Data |
| 13 | Length = 19 |
| 54 13 12 34 56 78 48 00 | Value |
| D0 90 61 01 90 00 99 00 | |
| 00 00 0F | |
| 9F 67 | Tag = Track2 ATC³ Digit Nr. |
| 01 | Length = 1 |
| 03 | Value |

| | |
|---|---|
| 90 00 | SW1 - SW2 |

¹Card Verification Code 3
²Unpredictable Number
³Application Transaction Counter

COMPUTE CRYPTOGRAPHIC CHECKSUM command

### Command

| Values | Comment |
|---|---|
| 80 2A | Command = Compute Cryptographic Checksum |
| 8E | P1 |
| 80 | P2 |
| 04 | Length = 4 |
| 00 00 08 99 | Value |
| 00 | Response length |

### Response

| Values | Comment | |
|---|---|---|
| 77 | Tag = Response Message Template | |
| 0F | Length = 15 | |
| 9F 61 | Value | Tag = CVC3¹ Track2 |
| 02 | | Length = 2 |
| B8 92 | | Value |
| 9F 60 | | Tag = CVC3¹ Track1 |
| 02 | | Length = 2 |
| FB C7 | | Value |
| 9F 36 | | Tag = App. Transaction Counter |
| 02 | | Length = 2 |
| 00 5E | | Value |

| | |
|---|---|
| 90 00 | SW1 - SW2 |

¹Card Verification Code 3

1. A transaction method between a secure processor and a transaction server, via a non-secure processor or a non-secure link, connected to a routing controller, the method comprising steps of:
the routing controller transmitting to the secure processor a command message sent by the non-secure processor or by the non-secure link,
the routing controller receiving a response message sent by the secure processor, and
the routing controller transmitting the response message to the non-secure processor or via the non-secure link,
characterized in that it comprises steps of:
the routing controller analyzing the content of the response message so as to detect data of a first type therein,
generating a modified message by removing from or by encrypting in the response message at least one portion of the data detected, and
transmitting the modified message to the non-secure processor or via the non-secure link.

2. Method according to claim 1, wherein the routing controller systematically analyzes the content of all the response messages received, without analyzing the content of the command messages.

3. Method according to claim 1, comprising steps of the routing controller analyzing the command message and of activating the analysis of the content of response messages if the analysis of the command message reveals that data of the first type is likely to be contained in a subsequent response message.

4. Method according to claim 2, comprising steps of:
determining for each command message received by the routing controller, whether data of the first type is likely to be contained in the corresponding response message, and
activating or deactivating the analysis of the content of the corresponding response message, depending on whether data of the first type is likely to be contained in the corresponding response message.

5. Method according to claim 1, wherein the routing controller modifies the data of the first type detected in the response message, generates a modified response message by replacing the detected data of the first type with the modified data in the response message, and transmits the modified response message to the non-secure processor.

6. Method according to claim 5, wherein the modification of the data of the first type detected in the response message comprises steps of transmitting the detected data to a secure processor connected to the routing controller, of the secure processor generating the modified data by encrypting at least one portion of the extracted data, and of the secure processor transmitting the modified data to the routing controller, the non-secure processor transmitting the modified response message to an intermediate server with a key identifier enabling the intermediate server to determine a decryption key, the intermediate server decrypting the encrypted data in the modified response message and restoring the original response message by replacing in the modified response message the encrypted data with the decrypted data, the restored response message being transmitted to a transaction server.

7. Method according to claim 1, wherein, when data of the first type has been detected in the response message, the routing controller transmits the response message to a secure processor connected to the routing controller and to the non-secure processor, the secure processor transmitting to the non-secure processor the response message in an encrypted form.

8. Method according to claim 1, wherein the content of messages is analyzed by the routing controller only if an operating mode indicator of the operating mode of the routing controller indicates that the routing controller is in a non-protected mode.

9. Method according to claim 1, wherein data of the first type is detected based on the value of tag fields contained in the response message.

10. Method according to claim 1, wherein the analysis of the content of the response message comprises a step of verifying that the length of a data field of the response message corresponds to the value of a length field contained in the response message.

11. Method according to claim 1, comprising a step of the routing controller analyzing the command message to determine a transaction protocol or a format of data exchanged between the non-secure processor and the NFC device, the transaction protocol or the data format thus determined being used to search for data of the first type in the response message.

12. A transaction system comprising a non-secure processor and a routing controller communicating with a secure processor,
wherein it is configured to implement the method according to claim 1, the routing controller being configured to:
analyze the content of a response message sent by the secure processor and intended for the non-secure processor or intended to be transmitted via a non-secure link, in response to a command message transmitted by the routing controller to the secure processor, so as to detect data of a first type therein,
generate a modified message by removing from or by encrypting in the response message at least one portion of the data detected, and
transmit the modified message to the non-secure processor or via the non-secure link.

13. Transaction system according to claim 12, wherein the secure processor is integrated into an integrated circuit card comprising a near field communication interface in NFC communication with the routing controller, or is connected to the routing controller.

14. Transaction system according to claim 12, wherein the routing controller is associated with a secure processor configured to:
receive all the response messages in a protected operating mode of the routing controller and only the response messages containing data of the first type in a non-protected operating mode, and
encrypt the messages received before transmitting them to the non-secure processor.

15. Transaction system according to claim 12, wherein the routing controller is associated with a secure processor configured to:
receive from the routing controller data of the first type extracted from the messages received by the routing controller,
encrypt the data of the first type received, and
transmit the encrypted data to the routing controller, the routing controller being configured to replace the data of the first type with the encrypted data received in the response message, and to transmit the response message thus modified to the non-secure processor.
